(19) United States
(12) Patent Application Publication
(10) Pub. No.: US 2020/0171756 A1
(43) Pub. Date: Jun. 4, 2020

(54) Method for the Ultrasonic Welding of a Strip

(71) Applicant: Max Schlatterer GmbGH & Co. KG, Herbrechtingen (DE)

(72) Inventors: Stefan RENNER, Ehingen (DE); Manfred STROBEL, Giengen-Sachsenhausen (DE); Andreas WAGNER, Nattheim (DE)

(73) Assignee: Max Schlatterer GmbH & Co. KG, Herbrechtingen (DE)

(21) Appl. No.: 16/614,774

(22) PCT Filed: May 18, 2018
(86) PCT No.: PCT/EP2018/063185

§ 371 Date: Nov. 18, 2019

(30) Foreign Application Priority Data
May 18, 2017 (EP) 17171751.5

(51) Int. Cl. B29C 65/08; B29C 65/00; D03D 3/04; D06H 5/00; A24C 5/18; A24D 3/02

(52) U.S. Cl. CPC B29C 65/08; B29C 66/4324; B29C 66/729; B29C 66/73776; B29C 66/73774; B29K 2071/00; D03D 3/04; D06H 5/001; A24C 5/1857; A24D 3/0233; B29C 66/73921

(57) ABSTRACT

The invention relates to a method for the ultrasonic welding of a strip consisting of a plastic material for the production of cigarette products, in which method the strip has two free ends which are heated in a connection region by means of ultrasound and joined together to form a closed strip. Ultrasound at a frequency of more than 22 kHz is used.

The invention relates to a method for the ultrasonic welding of a tape composed of a plastics material for the production of cigarette products according to the type defined in more detail in the preamble of claim 1. The invention furthermore relates to a tape for the production of cigarette products, having a woven fabric which has warp threads and weft threads that are composed of a plastics material, according to the preamble of claim 7.

A method of this type and such a tape are known from the general prior art. Ultrasonic welding is used for connecting a tape that previously had two free ends so as to form a continuous tape.

While said method has proven successful over the years, said method however requires a relatively high input in terms of time. A further disadvantage of ultrasonic welding lies in that the weft threads have to be removed in the connection region since otherwise no sufficient connection is created between the two free ends.

For this reason, laser beam welding such as described, for example, in DE 10 2011 006 803 A1, is nowadays being increasingly used for connecting the two free ends of a tape of this type.

However, laser beam welding also has certain disadvantages, specifically inter alia the requirement pertaining to the use of a light-absorbent material which prior thereto either has to be incorporated in the threads that form the woven fabric or in a film, which during welding is placed on the connection region of the two free ends.

It is therefore the object of the present invention to achieve a method for the ultrasonic welding of a tape composed of a plastics material for the production of cigarette products, as well as creating a tape for the production of cigarette products, by way of which the disadvantages of the previously used methods of ultrasonic welding and laser beam welding can be overcome.

This object is achieved according to the invention by the features mentioned in claim 1.

By using according to the invention an ultrasonic frequency of more than 22 kHz, more output is incorporated in the connection region which leads to a more rapid and/or more intensive melting of the warp and/or weft threads that form the woven fabric. A better connection of the two free ends so as to form the continuous tape can be achieved on account thereof.

The method according to the invention can optionally lead to weft threads also being able to be present in the connection region since said weft threads, as opposed to the previous approach, do not reduce the strength of the connection.

A further advantage of using such a high ultrasonic frequency of this type lies in that the installation, for example a sonotrode, required for generating the ultrasound can be embodied so as to be very much smaller than previously. On account thereof, such an ultrasonic generation installation can be integrated in the entire assembly for production of the tape more easily than previously, on account of which the entire process of producing the tape can be automated.

A further advantage of the solution according to the invention can lie in that additional materials such as films and the like that otherwise are optionally incorporated in the connection region can be dispensed with.

In one very advantageous refinement of the invention it can be provided that ultrasound at a frequency in a range from 22 to 100 kHz is used. Such an upper limit of the frequency of the ultrasound used for welding the two free ends of the tape has proven advantageous with a view to the output incorporated in the material.

In this context, even greater advantages in terms of the implementability of the method according to the invention are achieved when ultrasound at a frequency in a range from 25 to 60 kHz is used.

It can furthermore be provided that ultrasound at a frequency in a range from 30 to 45 kHz is used. This leads to further advantages with a view to incorporating output in the tape to be connected.

In practice, it has proven particularly advantageous when ultrasound at a frequency in a range from 32 to 38 kHz is used. At this frequency, particularly positive results in the connection region are achieved when connecting the two free ends of the tape.

It is particularly advantageous when ultrasound at a frequency in the range from 34 to 36 kHz is used. A frequency in a range of this type leads to excellent results in terms of the welding of the free ends of the tape so as to form a continuous tape for the production of cigarette products. The installation for generating the ultrasound used in the method can also be designed in a very compact manner on account of the use of such a frequency range.

A tape for the production of cigarette products is specified in claim 7.

The particular advantage of this type, the free ends thereof in the connection region being connected by means of ultrasonic welding, lies in the presence of weft threads in the entire connection region. This simplifies the production of the tape, on the one hand, since the weft threads no longer have to be removed prior to the ultrasonic welding. On the other hand, a higher strength of the tape can advantageously be achieved on account thereof.

An exemplary embodiment of the invention is schematically illustrated hereunder by means of the drawing.

In the drawing:

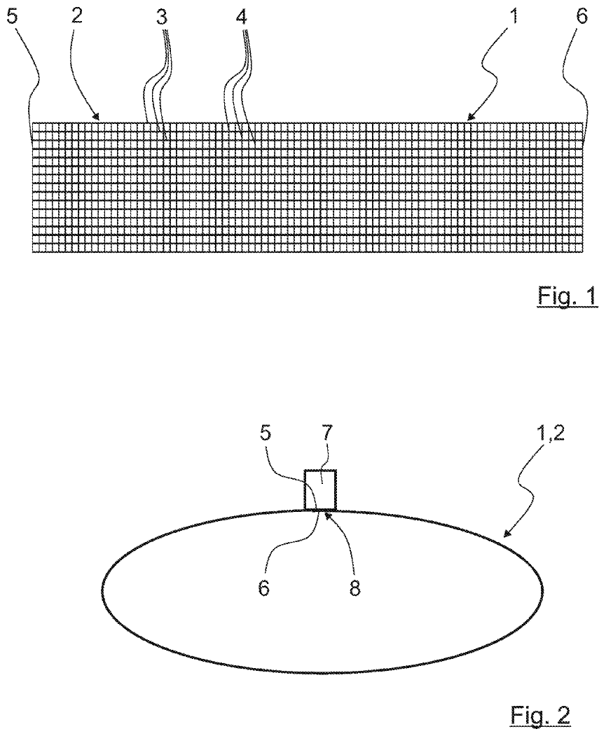

FIG. 1 shows a tape for the production of cigarette products prior to connecting the two free ends of said tape; and

FIG. 2 shows the tape from FIG. 1 in the ultrasonic welding.

FIG. 1 shows a tape 1 for the production of cigarette products (not illustrated) such as, for example, cigarettes, filters, or alternative cigarette products such as, for example, so-called e-cigarettes. The tape 1 can be a garniture tape for producing the cigarette product, or a suction tape for transporting tobacco.

When the tape 1 is configured as a garniture tape, it can be used in a machine in which filters for cigarettes are produced in the form of continuous or at least comparatively long filter strands which are also referred to as filter tows, for example. The garniture tape could also be used as a vacuum tape for transporting various objects or materials such as, for example, tobacco or filter material. In the case of the tape 1 being embodied as a suction tape, said suction tape can be used for transporting tobacco fibers, for example. Since garniture tapes as well as suction tapes are known in principle, the specific use thereof will however not be discussed in more detail here.

The tape 1 has a woven fabric 2 which in a manner known per se is composed of warp threads 3 and weft threads 4. Since the production of the woven fabric 2 from the warp threads 3 and the weft threads 4 is also known per se, this is likewise not discussed in more detail here. It is only to be mentioned that the weft threads 4 are situated so as to be continuous on both free ends 5 and 6 of the tape 1, that is to say that said weft threads 4 are not removed prior to connecting the two free ends 5 and 6 of the tape 1 as described hereunder.

The warp threads 3 as well as the weft threads 4 are composed of a plastics material, preferably of a polymer material having a crystalline or semi-crystalline structure. The polymer material is in particular a material from the polyetherketone family. The materials PEK, PEEK, PEKK, PEEKK are particularly preferable. The warp threads 3 and the weft threads 4 are preferably monofilament threads.

A step of a method for the ultrasonic welding of the two free ends 5 and 6 of the tape 1 so as to form a continuous tape is illustrated in FIG. 2. By means of an ultrasonic generation installation 7, for example a sonotrode, the tape 1 in a connection region 8 in which the two free ends 5 and 6 are placed on top of one another, herein is heated by ultrasonic means, on account of which the two free ends 5 and 6 of the tape 1 are connected to one another such that a continuous tape 1 is created. The woven fabric 2 of the tape 1 produced in this manner has the weft threads 4 in the entire connection region 8.

Ultrasound at a frequency of more than 22 kHz is used in the heating of the two free ends 5 and 6 of the tape 1. Ultrasound at a frequency from 22 to 100 kHz is more preferably used. Ultrasound at a frequency in a range from 25 to 60 kHz is more preferably used. Ultrasound at a frequency in a range from 30 to 45 kHz is more preferably used. Ultrasound at a frequency in a range from 32 to 38 kHz is more preferably used. Most preferably, ultrasound at a frequency in a range from 34 to 36 kHz is used.

The ultrasonic generation installation 7, or the sonotrode, respectively, can be part of an entire device by way of which the tape 1 can optionally be produced in a fully automatic manner.

1. A method for the ultrasonic welding of a tape composed of a plastics material for the production of cigarette products, wherein the tape has two free ends which in a connection region by ultrasonic means are heated and connected to one another so as to form a closed tape,
characterized in that
ultrasound at a frequency of more than 22 kHz is used.

2. The method as claimed in claim 1,
characterized in that
ultrasound at a frequency in a range from 22 to 100 kHz is used.

3. The method as claimed in claim 1,
characterized in that
ultrasound at a frequency in a range from 25 to 60 kHz is used.

4. The method as claimed in one of claim 1,
characterized in that
ultrasound at a frequency in a range from 30 to 45 kHz is used.

5. The method as claimed in one of claim 1,
characterized in that
ultrasound at a frequency in a range from 32 to 38 kHz is used.

6. The method as claimed in one of claim 1,
characterized in that
ultrasound at a frequency in a range from 34 to 36 kHz is used.

7. A tape for the production of cigarette products, having a woven fabric which has warp threads and weft threads that are composed of a plastics material, said tape in a connection region being connected by ultrasonic welding,
characterized in that
the woven fabric has warp threads in the entire connection region.
